(19) United States
(12) Patent Application Publication
(10) Pub. No.: US 2007/0230792 A1
(43) Pub. Date: Oct. 4, 2007

(54) Pedestrian Detection

(75) Inventors: Amnon Shashua, Mevasseret Zion (IL); Yoram Gdalyahu, Jerusalem (IL); Gabi Hayon ( Avni), Jerusalem (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Mobileye Technologies Ltd., Nicosia (CY)

(21) Appl. No.: 10/599,635

(22) PCT Filed: Apr. 7, 2005
(86) PCT No.: PCT/IL05/00381

§ 371 Date: Oct. 4, 2006

Related U.S. Application Data
(60) Provisional application No. 60/560,050, filed on Apr. 8, 2004.

(51) Int. Cl. G06K 9/00

(52) U.S. Cl. 382/190; 382/227

(57) ABSTRACT

A classifier for determining whether an instance belongs to a particular class of instances of a plurality of classes, the classifier comprising: a plurality of first classifiers that operate on an instance to provide an indication as to which class the instance belongs, each of which classifiers is trained on a different subset of training instances from a same set of training instances wherein each training subset comprises a group of training instances that share at least one characteristic trait and different subsets have a different at least one characteristic trait; and a second classifier that operates on the indications provided by the first classifiers to provide an indication as to which class the instance belongs.

### RELATED APPLICATIONS

The present application claims benefit under 35 U.S.C. 119(e) of U.S. Provisional Application 60/560,050 filed on Apr. 8, 2004, the disclosure of which is incorporated herein by reference.

### FIELD OF THE INVENTION

The present invention relates to methods of determining presence of an object in an environment from an image of the environment and by way of example, methods of detecting a person in an environment from an image of the environment.

### BACKGROUND OF THE INVENTION

Automotive accidents are a major cause of loss of life and dissipation of resources in substantially all societies in which automotive transportation is common. It is estimated that over 10,000,000 people are injured in traffic accidents annually worldwide and that of this number, about 3,000,000 people are severely injured and about 400,000 are killed. A report “The Economic Cost of Motor Vehicle Crashes 1994” by Lawrence J. Blincoe, published by the United States National Highway Traffic Safety Administration, estimates that motor vehicle crashes in the U.S. in 1994 caused about 5.2 million nonfatal injuries, 40,000 fatal injuries and generated a total economic cost of about $150 billion.

The damage and costs of vehicular accidents have generated substantial interest in collision warning/avoidance systems (CWAS) that detect potential accident situations in the environment of a driver's vehicle and alert the driver to such situations with sufficient warning to allow him or her to avoid them or to reduce the severity of their realization. In relatively dense population environments typical of urban environments, it is advantageous for a CWAS system to be capable of detecting and alerting a driver to the presence of a pedestrian or pedestrians in the path of a vehicle.

Methods and systems exist for acquiring an image of an environment and processing the image to detect presence of a person. Some person detection systems are motion based systems and determine presence of a person in an environment by identifying periodic motion typical of a person walking or running in a series of images of the environment. Other systems are “shape-based” systems that attempt to identify a shape in an image or images of an environment that corresponds to a human shape. A shape-based detection system typically comprises at least one classifier that is trained to recognize a human shape by training the detection system to distinguish human shapes in a set of training images of environments, some of which training images contain human shapes and others of which do not.

A global shape-based detection system operates on an image to detect a human shape as a whole. However, the human shape, because it is highly articulated displays a relatively high degree of variability and people are often located in environments in which they are relatively poorly contrasted with the background. As a result, global shape-based classifiers are often difficult to train so that they are capable of providing equally consistent and satisfactory performance for different configurations of the human shape and different environmental conditions.

Component shape-based detection systems, (CBDS), appear to be less sensitive to variability of the human shape and differences in environmental conditions, and appear to offer more robust reliability for detection of persons than global shape-based detection systems. Component based detection systems determine presence of a person in a region of an image by providing assessments as to whether components of a human body are present in sub-regions of the region. The sub-region assessments are then combined to provide an holistic assessment as to whether the region comprises a person. “Component classifiers” and a “holistic classifier” comprised in the CBDS, and trained on a suitable training set, make the sub-region assessments and the holistic assessment respectively.

An article, “Pedestrian Detection Using Wavelet Templates”; Oren et al Computer Vision and Pattern Recognition (CVPR) June 1997 describes a global shape-based detection system for detecting presence of a person. The system uses Haar wavelets to represent patterns in images of a scene and a support vector machine classifier to process the Haar wavelets to classify a pattern as representing a person. A CBDS is described in “Example Based Object Detection in Images by Components”; A. Mohan et al; IEEE Transactions on Pattern Analysis and Machine Intelligence; Vol 23, No. 4; April 2001. The disclosures of the above noted references are incorporated herein by reference.

### SUMMARY OF THE INVENTION

An aspect of some embodiments of the present invention relates to providing an improved component based detection system (CBDS) comprising component and holistic classifiers for detecting a given object in an environment from an image of the environment.

An aspect of an embodiment of the invention relates to providing a configuration of classifiers for the CBDS that provides improved discrimination for determining whether an image of the environment contains the object.

An aspect of some embodiments of the present invention relates to providing a method of using a set of training examples to teach classifiers in a CBDS that improves the ability of the CBDS to determine whether an image of the environment contains the given object.

In some embodiments of the invention, the object is a person. Optionally, the CBDS is comprised in an automotive collision warning and avoidance system (CWAS).

The inventors have determined that reliability of a component classifier in recognizing a component of a given object in an image, in general tends to degrade as variability of the component increases. For example, assume that the object to be identified in an environment is a person, and that the CBDS operates to identify a person in a region of interest (ROI) of an image of the environment. A component based classifier that processes image data in a sub-region of the ROI in which the person's arm is expected to be located has to contend with a relatively large variability of the image data. An arm generates different image data which may depend upon, for example, whether a person is walking from right to left or left to right in the image, whether the arm is straight or bent, and if bent by how much, and if the person is wearing a long sleeved shirt or a short sleeved shirt. The relatively large variability in image data generated by “an arm” tends to reduce the reliability with which the component provides a correct answer as to whether an arm is present in the sub-region that it processes.

To ameliorate the effects of component variability on performance of classifiers in a CBDS and improve their performance, in accordance with an embodiment of the invention, images from a set of training images used to teach the classifiers to recognize an object are used to provide a plurality of training subsets. Each subset comprises images, hereafter “positive images” that comprise an image of the object and an optionally equal number of images, hereinafter “negative images”, that do not comprise an image of the object.

In accordance with an embodiment of the invention, for each of a plurality of the subsets, referred to as positive subsets, all the positive images in the subset share at least one common, characteristic trait different from the characteristic traits shared by images of the other training subsets. The training images in a same positive training subset therefore exhibit greater mutual commonality and less variability than do the positive training images in the complete set of training images.

Optionally, the training subsets comprise at least one negative subset. Similarly to the case for positive training subsets, negative images in a same negative training subset share at least one common, characteristic trait different from the characteristic traits shared by negative images of the other negative training subsets.

In accordance with an embodiment of the invention, each training subset is used to train a component classifier for each of the sub-regions of an ROI to provide an assessment as to the presence of the object in the ROI from image data in the sub-region. Since each training subset is characterized by at least one characteristic trait common to all the positive or the negative images in the subset that is different from a characteristic trait of the other subsets, each subset generates a component classifier for each sub-region that has a “sensitivity” different from that of component classifiers for the sub-region trained by the other training subsets. Each sub-region is therefore associated with a plurality of component classifiers equal in number to the number of different training subsets. A plurality of component classifiers associated with a same sub-region is referred to as a “family” of component classifiers.

After each of the component classifiers is trained, a holistic classifier is trained to combine assessments provided by all the component classifiers operating on an ROI of an image to provide an assessment as to whether or not the object is present in the ROI. The holistic classifier is optionally trained on the complete set of training images. Each of the training images is processed by all the component classifiers and the holistic classifier is trained to process their assessments of the images to provide holistic assessments as to whether or not the images comprise the object.

By way of example of operation of a CBDS in accordance with an embodiment of the invention, assume a CBDS trained as described above, which is used to determine presence of a person in a region of a given environment from a corresponding ROI in an image of the environment. The ROI is partitioned into sub-regions corresponding to sub-regions for which the families of component classifiers in the CBDS were trained and each sub-region is processed by each of the component classifiers in its associated family of classifiers to provide an assessment as to the presence of a person in the ROI. The assessments of all of the component classifiers are then combined by the CBDS's holistic classifier, using a suitable algorithm, to determine whether or not the object is present.

The inventors have found that it is possible to train the component classifiers of a CBDS in accordance with an embodiment of the invention with a relatively small portion of a total number of training images in a training set. In some embodiments of the invention a positive or negative training subset of images comprises less than or equal to 10% of the total number of images in the training set. In some embodiments of the invention, the number of training images in a training subset is less than or equal to 5%. Optionally the number of images in a training subset is less than or equal to 3%.

The inventors have found that for a given false detection rate, a CBDS used to recognize a person in accordance with an embodiment of the invention, provides a better positive detection rate for recognizing a person than prior art global or component shape-based classifiers. A false detection refers to an incorrect determination by the CBDS that a person is present and a positive detection refers to a correct determination that a person is present in the environment.

There is therefore provided in accordance with an embodiment of the invention, a classifier for determining whether an instance belongs to a particular class of instances of a plurality of classes, the classifier comprising: a plurality of first classifiers that operate on an instance to provide an indication as to which class the instance belongs, each of which classifiers is trained on a different subset of training instances from a same set of training instances wherein each training subset comprises a group of training instances that share at least one characteristic trait and different subsets have a different at least one characteristic trait; and a second classifier that operates on the indications provided by the first classifiers to provide an indication as to which class the instance belongs.

Optionally, each first classifier operates on a portion of an instance and a plurality of first classifiers operates on at least one portion of the instance.

Additionally or alternatively, a training subset of instances comprises a relatively small number of the total number of instances comprised in the set of training instances. Optionally, the number of instances is less than or equal to 10% of the total number of instances. Optionally, the number of instances is less than or equal to 5% of the total number of instances. Optionally, the number of instances is less than or equal to 3% of the total number of instances.

In some embodiments of the invention, the instances are images and the classifier determines whether an image comprises an image of a particular feature to determine to which class the image belongs. Optionally, the feature is a person.

There is further provided an automotive collision warning and avoidance system comprising a classifier in accordance with an embodiment of the invention.

There is further provided in accordance with an embodiment a method of using a set of training instances to train a classifier comprising a plurality of first classifiers that operate on an instance to indicate a class of instances to which the instance belongs and a second classifier that uses indications provided by the first classifiers to determine a class to which the instance belongs, the method comprising: grouping training instances from the set of training instances into a plurality of subsets of training instances wherein each training subset comprises a group of training instances that share at least one characteristic trait and different subsets have a different same at least one characteristic trait; training each of the first classifiers on a different one of the training subsets; and training the second classifier on substantially all the training instances.

Optionally, the method comprises partitioning each instance into a plurality of portions and training a first classifier for each portion and a plurality of first classifiers for at least one portion.

Additionally or alternatively, a training subset of instances comprises a relatively small number of the total number of instances comprised in the set of training instances. Optionally, the number of instances is less than or equal to 10% of the total number of instances. Optionally, the number of instances is less than or equal to 5% of the total number of instances. Optionally, the number of instances is less than or equal to 3% of the total number of instances.

In some embodiments of the invention the instances are images and the classifier is trained to determine whether an image comprises an image of a particular feature to determine to which class the image belongs. Optionally, the feature is a person.

There is further provided a classifier for determining a class to which an instance is represented by a descriptor vector in a space of vectors belongs comprising: a plurality of sets of training vectors wherein vectors that belong to a same set represent training instances in a same class of instances and training vectors belonging to different sets represent training instances belonging to different classes of instances; and an operator that determines for each set of vectors projections of the descriptor vector on all the training vectors in the set and determines to which class the instance belongs responsive to the projections on the sets.

Optionally, the operator determines for each set of vectors a sum of the squares of the projections and that the instance belongs to the class of instances corresponding to the set of vectors for which the sum is largest.

There is further provided in accordance with an embodiment of the invention, a method of classifying an instance represented by a descriptor vector comprising: providing a plurality of sets of training descriptor vectors wherein vectors that belong to a same set represent training instances in a same class of instances and training vectors belonging to different sets represent training instances belonging to different classes of instances; determining for each set of training vectors projections of the descriptor vector on all the training vectors in the set; and determining to which class the instance belongs responsive to the projections. Optionally, determining a sum of the squares of the projections for each set and that the instance belongs to the class of instances corresponding to the set of training vectors for which the sum is largest.

### BRIEF DESCRIPTION OF FIGURES

Non-limiting examples of embodiments of the present invention are described below with reference to figures attached hereto, which are listed following this paragraph. In the figures, identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1 schematically shows an image in which a person is located and sub-regions of the image that are processed by a component classifier to identify the person, in accordance with an embodiment of the invention;

FIG. 2 schematically shows the sub-regions shown in FIG. 1 divided into a plurality of sampling regions that are used in processing the image in accordance with an embodiment of the invention;

FIG. 3 schematically shows a method of generating a vector that is used as a descriptor in processing the image in accordance with an embodiment of the invention; and

FIG. 4 shows a graph of performance curves for comparing performance of prior art classifiers with a classifier in accordance with an embodiment of the invention.

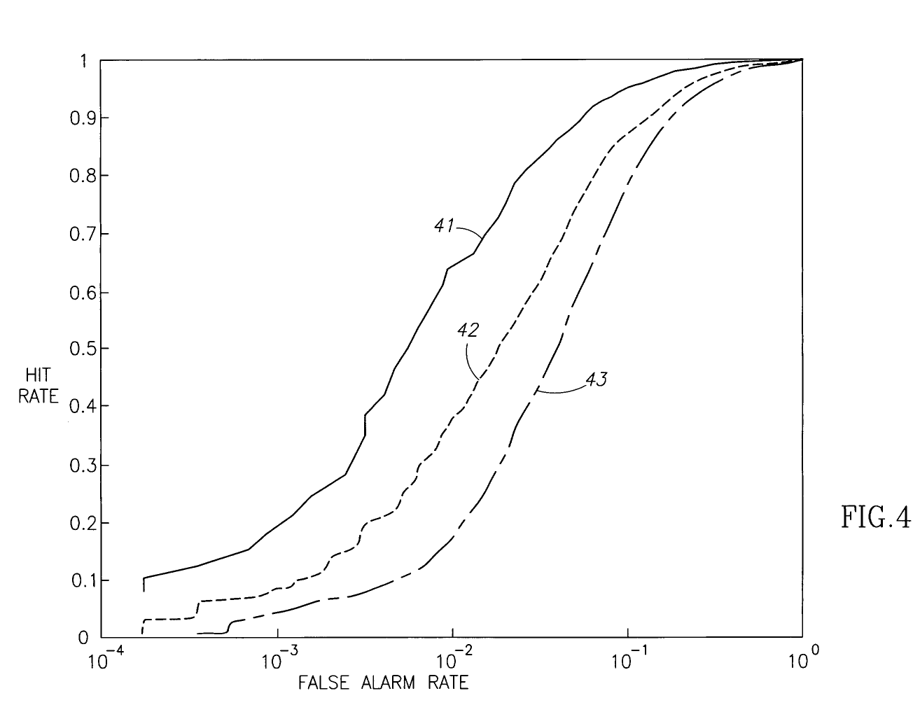

### DETAILED DESCRIPTION OF EXEMPLARY EMBODIMENTS

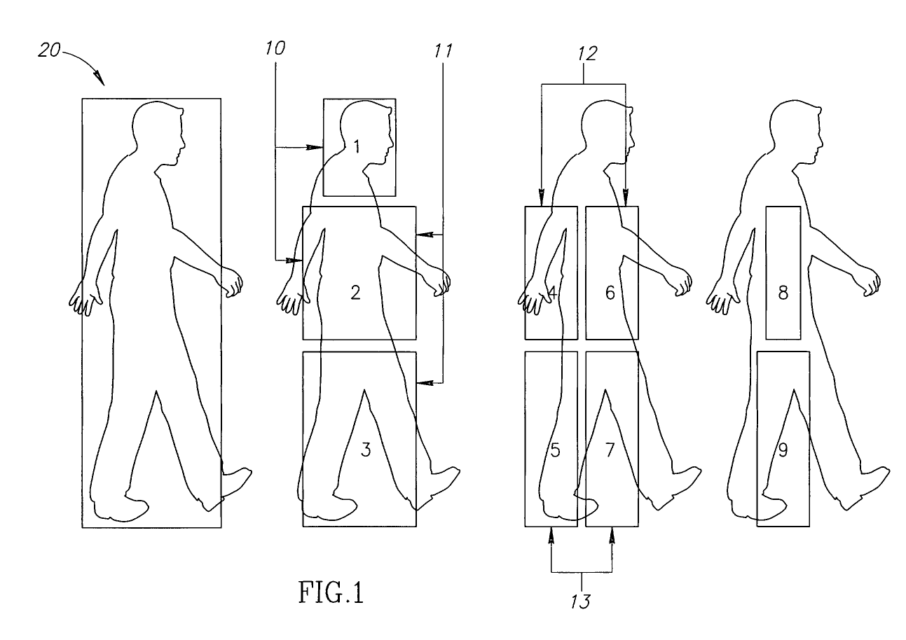

FIG. 1 schematically shows an example of a training image 20 from a set of training images that is used to train a holistic classifier and component classifiers in a CBDS to determine presence of a person in an image of a scene, in accordance with an embodiment of the invention. The set of training images comprises positive training images in which a person is present and negative training images in which a person is not present. Each of the positive training images optionally comprises a substantially complete image of a person. Training image 20 is an exemplary positive training image from the training image set.

In accordance with an embodiment of the invention, images from the totality of training images in the training set are used to provide a plurality of positive and optionally negative training subsets. Each subset contains an optionally equal number of positive and negative training images. The positive training images in a same positive training subset share at least one common characteristic trait that is not in general shared by positive images from different training subsets. The at least one common characteristic optionally comprises a pose, an articulation or an illumination ambience. As a result, images in a same training subset in general exhibit a greater commonality of traits and less variability than do positive training images in the complete set of images. Similarly, the negative images in a same negative training subset share at least one common characteristic trait that is not in general shared by negative images from different training subsets. For example, a negative subset may comprise images of street signs, while another may comprise images having building structural forms that might be mistaken for a person and yet another might be characterized by relatively poor lighting and indistinct features. As a result, negative images in a same negative training subset in general exhibit a greater commonality of traits and less variability than do negative training images in the complete set of images.

In some embodiments of the invention, a positive or negative training subset of images comprises less than or equal to 10% of the total number of images in the training set. In some embodiments of the invention, the number of training images in a training subset is less than or equal to 5%. Optionally the number of images in a training subset is less than or equal to 3%.

By way of example, positive images in a training set are used to optionally generate nine positive training subsets in each of which images are characterized by a person in a same pose that is different from poses that characterize images of persons in the other positive subsets. Optionally, a first subset comprises images in which a person is facing left and has his or her legs relatively close together. A second “reversed” subset optionally comprises the images in the first subset but with the person facing right. A third subset and a reversed fourth subset optionally comprise images in which a person exhibits a wide stride and faces respectively left and right. Fifth and sixth subsets optionally comprise images in which a person is facing respectively left and right and appears to be completing a step with a back leg bent at the knee. Optionally, seventh and eight training subsets comprise images in which a person faces left and right respectively and appears to be in the initial stages of a step with a forward leg raised at the thigh and bent at the knee. A ninth subset optionally comprises images in which a person is moving towards or away from a camera that acquires the images. Training image 20 is an exemplary image from the second training subset.

In accordance with an embodiment of the invention, a component classifier is trained by each positive subset for each sub-region of the plurality of sub-regions into which an image to be processed by the CBDS is partitioned. Similarly, optionally, a component classifier is trained by each negative subset for each sub-region of the plurality of sub-regions into which an image to be processed by the CBDS is partitioned. As a result, a family of component classifiers equal in number to the number of positive and negative training subsets is generated for each sub-region of images processed by the CBDS. In some embodiments of the invention, a component classifier for at least one sub-region is trained by a number of training sets different from a number of training sets that are used to train classifiers for another sub-region. For example a classifier for a sub-region that in general is characterized by more detail than another sub-region may be trained on more training subsets than the other region. After the component classifiers are trained, a holistic classifier is trained to determine presence of a person in an image responsive to results provided by the component classifiers processing the image. Optionally, all the images in the complete training set are used to train the holistic classifier.

Let the number of sub-regions into which an image processed by the CBDS is partitioned be represented by I and the number of training subsets be J. Let the number of training images in a j-th training subset be T(j)

For an “i-th” sub-region of an image processed by the CBDS, a normalized descriptor vector x(i)εR^{N} in a space of N dimensions is defined that characterizes image data in the sub-region. In accordance with an embodiment of the invention, the descriptor vector is processed by each of the J component classifiers in the family of classifiers associated with the sub-region to provide an indication as to whether an image of a person is or is not present in the image. Optionally, the j-th classifier associated with the i-th sub-region (i.e. the i,j-th component classifier) comprises a weight vector wᵢⱼ that defines a hyperplane in R^{N}. The hyperplane substantially separates descriptor vectors x(i) associated with positive training images from descriptor vectors x(i) associated with negative training images.

Optionally, the i, j-th component classifier generates a value, hereafter a discriminant value,

$$y ( i , j ) = {\sum }_{n} {w ( i , j )}_{n} {x ( i )}_{n} \qquad 1 )$$

to indicate whether the image comprises an image of a person. Optionally, y(i,j) has a range from −1 to plus 1 and indicates presence of a human image in an image for positive values and absence of a human image for negative values.

Optionally, the weight vector wᵢⱼ is determined using Ridge Regression so that the weight w(i,j) is a vector that minimizes an equation of the form

$$α {\vert w ( i , j ) \vert}^{2} + {\sum }_{t , n} {( y ( j , t ) - {w ( i , j )}_{n} \times {( i , t )}_{n} )}^{2} \qquad 2 )$$

where x(i,t) is the descriptor vector for the i-th sub-region of the t-th training image in the j-th training subset. The indices t and n take on values from 1 to T(j) and 1 to N respectively. The discriminant y(j,t) is assigned a value of 1 for a t-th training image if the training image is positive and a value −1 if the training image is negative and α is a parameter determined in accordance with any various Ridge Regression methods known in the art.

In some embodiments of the invention, the holistic classifier determines whether or not the discriminants y(i,j) indicate presence of a person in the image responsive to the value of a holistic discriminant function Y, which is defined as a function of the y(i,j) of the form,

$$Y = {\sum }_{i , j , k} {W}_{i , j , k} \times [ IF ( \begin{matrix}{σ}_{ i , j , k} \times y ( i , j ) \geq {θ}_{ i , j , k} , \\ then y ( i , j ) = 1 , else 0\end{matrix} ) ] . \qquad 3 )$$

The holistic classifier determines that the image comprised a human form if
Y≧Ω. 4)

In the expression for Y, W_{i,j,k} is a weighting function, θ_{i,j,k} is a threshold and σ_{i,j,k} assumes a value of 1 or −1 depending on whether y(i,j) is required to be greater than θ_{i,j,k} or less than θ_{i,j,k} respectively. The indices i and j, as noted above, indicate a sub-region of the image and a training image subset and refer to the sub-region and respectively take on values from 1 to I and 1 to J. The index k provides for a possibility that a discriminant y(i,j) may contribute to Y differently for different values of y(i,j) and therefore may be associated with more than one θ_{i,j,k} and weight W_{i,j,k}. For example, if y(i,j) is negative, it might be a poor indicator as to the presence of a person and therefore not contribute at all to Y. If it has a value between 0 and 0.25 it may contribute slightly to Y, and if it has a value greater than 0.25 it might be a very strong indicator of the presence of a person and therefore contribute substantially to Y. For such a case k=2 and y(i,j) is associated with two thresholds (0 and 0.25) and two corresponding weights W_{i,j,k}. The weight W_{i,j,k} is applied to a discriminant y(i,j) only if y(i,j) satisfies the conditional constraint in the square brackets, in which case the expression in the square bracket acquires the value y(i,j). Otherwise, the square bracket takes on the value 0. In the constraint equation 4), Ω represents an holistic threshold.

The weights W_{i,j,k}, thresholds θ_{i,j,k}, values of the sign function σ_{i,j,k} and a range for the index k, which is optionally a function of the indices i and j, are optionally determined using any of various Adaboost training algorithms known in the art. It is noted that W_{i,j,k} as a function of indices i, j, and k may acquire positive or negative values or be equal to zero. Adaboost, and a desired balance between a positive detection rate for correctly determining presence of a human form in an image and a false detection rate, optionally determine a value for the threshold Ω.

The inventors have tested an exemplary CBDS for determining presence of a person in an image in accordance with an embodiment of the invention having a configuration similar to that described above. In accordance with the exemplary CBDS, images processed by the CBDS were partitioned into 13 sub-regions. The sub-regions comprised sub-regions labeled 1-9 and compound sub-regions 10-13 shown in FIG. 1. Compound sub-regions 10, 11, 12 and 13 are combinations of sub-regions 1 and 2, 2 and 3, 4 and 6 and 5 and 7 respectively.

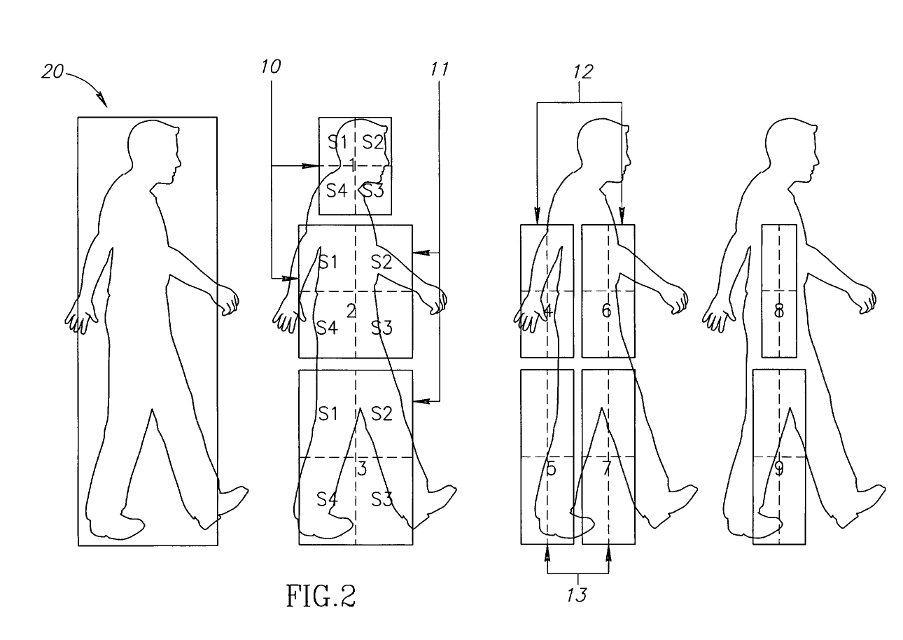

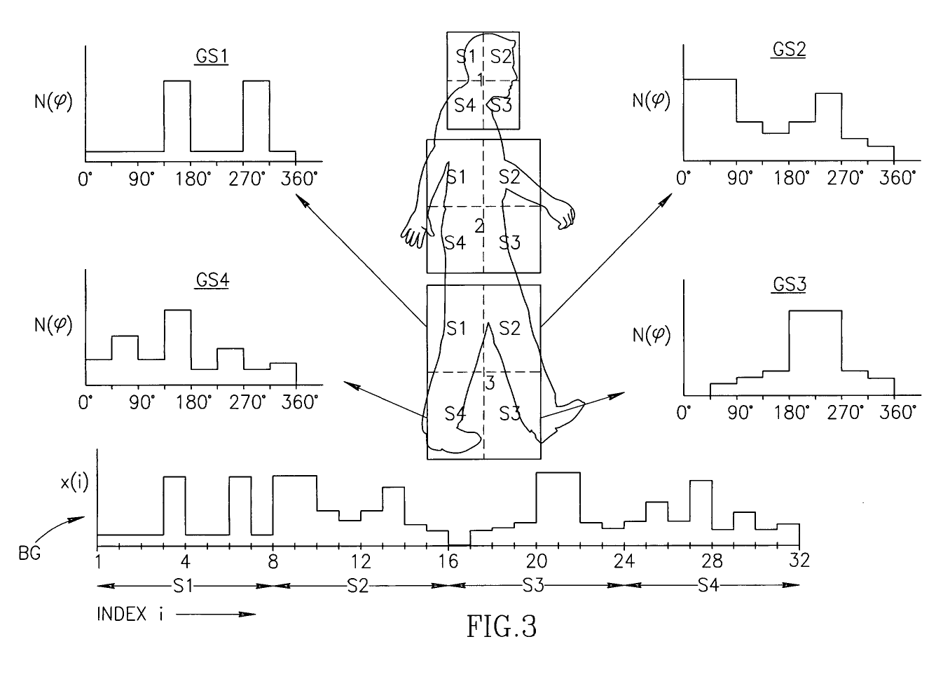

To determine a descriptor vector x(i) for each sub-region, 1≦i≦9, of a given image, each sub-region was divided into optionally four equal rectangular sampling regions labeled S1-S4, which are shown in FIG. 2. For each of a plurality of optionally all pixels in a sampling region, an angular direction φ for the gradient of image intensity at the location of the pixel was determined. For each sampling region S1-S4, the number of pixels N(φ) as a function of gradient direction was histogrammed in a histogram having eight 45° angular bins that spanned 360°. FIG. 3 shows schematic histograms GS1, GS2, GS3, and GS4 of N(φ) in accordance with an embodiment of the invention for regions S1-S4 respectively of sub-region 3. Each sub-region was therefore associated with 32 angular bins (4 sampling regions×8 angular bins per sampling region). The numbers of pixels in each of the 32 angular bins was normalized to the total number of pixels in the sub-region for which gradient direction was determined. The normalized numbers defined a 32 element descriptor vector x(i) (i.e. xεR³²) for the sub-region schematically shown as a bar graph BG in FIG. 3. For each of the four compound sub-regions 10-13 of the image, a 64 element descriptor vector was formed by concatenating the descriptor vectors determined for the sub-regions comprised in the compound sub-region.

A training set comprising 54,282 training images approximately equally split between positive and negative training images was generated by choosing regions of interest from camera images captured at a 640×480 resolution with a horizontal field of view of 47 degrees. The images were acquired during 50 hours of driving in city traffic conditions at locations in Japan, Germany, the U.S. and Israel. The regions of interest were scaled up or down as required to fill a region of 16×40 pixels. Training images were hand chosen from the set of training images to provide nine small positive training sets for training component classifiers. Each positive training set contained between 700 and 2200 positive training images and an equal number of negative images

The nine training subsets were used to train nine component classifiers for each sub-region 1-13 in accordance with equation 2). The CBDS therefore generated a value for each of a total of 117 (13 sub-regions×9 component classifiers) discriminants y(i,j) for an image that it processed. A holistic classifier in accordance with equations 3) and 4) processed the discriminant values. The holistic classifier was trained on all the images in the training set using an Adaboost algorithm.

Following training, a total of 15,244 test images were processed by the CBDS to determine its ability to distinguish the human form in images. Performance of the CBDS is graphed by a performance curve 41 in a graph 40 presented in FIG. 3. A rate of positive, i.e. correct detections of the CBDS is shown along the graph's ordinate as a function of a false alarm rate, shown along the abscissa, for which the holistic threshold Ω (equation 4) is set. For comparison, performance curves 42 and 43 graph performance of prior art classifiers operating on the same set of test images used to test performance shown by curve 41 of the CBDS in accordance with the invention. Curves 42 and 34 respectively graph performance of prior art CBDS classifiers described in the articles “Example Based Object Detection in Images by Components” and “Pedestrian Detection Using Wavelet Templates” cited above. A comparison of curves 41, 42 and 43 show that for every false alarm rate, the CBDS in accordance with an embodiment of the present invention performs better than the prior art classifiers and substantially better for false alarm rates less than about 0.5.

It is noted that a number of sub-regions and sampling regions defined for a CBDS in accordance with an embodiment of the invention may be different from that described in the above example. In some embodiments of the invention, an image may not be divided into sub-regions and a plurality of component classifiers may be trained, in accordance with and embodiment of the invention, by different training subsets on the whole image. Furthermore, whereas histogramming gradient angular direction was performed using equal width angular bins of 45°, it is possible and can be advantageous to use bins having widths other than 45° and bins of unequal width. For example, if images of an object have a distinguishing feature that is expressed by a hallmark shape in a particular sub-region, it can be advantageous to provide a finer angular binning for a portion of the 360° angular range of the intensity gradients in the sub-region.

It is further noted that classifiers used in the practice of the present invention are not limited to the classifiers described in the above discussion of exemplary embodiments of the invention. In particular, the invention may be practiced using a new inventive classifier developed by the inventors.

Assume for example that positive and negative instances in a training set of instances are respectively described by descriptor vectors P(p) and N(n) in a space R^{M}, where p and n are indices that indicate particular positive and negative instances and have respectively maximum values P and N. The training instances may be for training a classifier to perform any suitable “classification” task. By way of example, the instances may be training images used to train a classifier to recognize an object.

A classifier in accordance with an embodiment of the invention, classifies a new, non-training, instance described by a normalized descriptor vector x, responsive to a value of a discriminant function Y(x) determined in accordance with a formula,

$$Y ( x ) = ( 1 / P ) {\sum }_{p , m}^{P , M} {( {P ( p )}_{m} {x}_{m} )}^{2} - ( 1 / N ) {\sum }_{n , m}^{N , M} {( {N ( n )}_{m} {x}_{m} )}^{2} \qquad 5 )$$

and optionally determines that the new instance belongs to the class of positive instances if
Y(x)≧Ω 6)

The expression for Y(x) be expressed in the form
Y(x)=x^{t}·A·x, 7)
where x^{t} is the transpose of the vector x and A is a matrix of the form

$$A = ( 1 / P ) {\sum }_{p}^{P} {P ( p )}^{t} \cdot {P ( p )}^{t} - ( 1 / N ) {{\sum }_{n}}^{N} N ( n ) \cdot {N ( n )}^{t} . \qquad 8 )$$

The matrix A has a dimension M×M and its size may make calculations using the matrix computer resource intensive and may result in such calculations monopolizing an inordinate amount of available computer time. To reduce computer resource that such calculations may require, in some embodiments of the invention, the matrix A is approximated using a singular value decomposition (SVD) so that,

$$A = {\sum }_{i}^{r} {σ}_{i} {v}_{i} {v}_{i}^{t} \qquad 9 )$$

where r is the rank of the matrix A, the vectors v are the singular vectors of the decomposition, and σᵢ the singular values of the decomposition.

Rewriting equation 7) using equation 9) provides an expression of the form

$$Y ( x ) = {x}^{t} \cdot {{\sum }_{i}}^{r} {σ}_{i} {v}_{i} {v}_{i}^{t} \cdot x = {\sum }_{i}^{r} {{σ}_{i} ( {v}_{i}^{t} \cdot x )}^{2} , \qquad 10 )$$

which in an embodiment of the invention is approximated to reduce the complexity of computations with the matrix A by the expression,

$$Y ( x ) \sim {\sum }_{i}^{{r}^{*}} {{σ}_{i} ( {v}_{i}^{t} \cdot x )}^{2} , \qquad 11 )$$

where r* is less than r.

The inventors have determined that performance of the classifier can be improved, in accordance with an embodiment of the invention, by replacing the singular values σᵢ with weights from a weighting vector w having components determined responsive to the set of positive and negative descriptor vectors P(p) and N(n). Any of various methods may be used to fit the weighting vector to the descriptor vectors. Optionally a regression method is used to fit the weighting vector. For example, the weighting vector may be a least squares solution to an equation of the form,

$$[ \begin{matrix}{( {v}_{1}^{t} \cdot P ( 1 ) )}^{2} & {( {v}_{ 1}^{ t} \cdot P ( 2 ) )}^{2} & {( {v}_{ 1}^{ t} \cdot P ( 3 ) )}^{2} & ⋯ & {( {v}_{1}^{t} \cdot P ( M ) )}^{2} \\ {( {v}_{2}^{t} \cdot P ( 1 ) )}^{2} & {( {v}_{2}^{t} \cdot P ( 2 ) )}^{2} & {( {v}_{2}^{t} \cdot P ( 3 ) )}^{2} & ⋯ & {( {v}_{2}^{t} \cdot P ( M ) )}^{2} \\ ⋯ & ⋯ & ⋯ & & \\ {( {v}_{P}^{t} \cdot P ( 1 ) )}^{2} & {( {v}_{P}^{t} \cdot P ( 2 ) )}^{2} & {( {v}_{P}^{t} \cdot P ( 3 ) )}^{2} & ⋯ & {( {v}_{P}^{t} \cdot P ( M ) )}^{2} \\ {( {v}_{1}^{t} \cdot N ( 1 ) )}^{2} & {( {v}_{1}^{t} \cdot N ( 2 ) )}^{2} & {( {v}_{1}^{t} \cdot N ( 3 ) )}^{2} & ⋯ & {( {v}_{1}^{t} \cdot N ( M ) )}^{2} \\ ⋯ & ⋯ & ⋯ & & \\ {( {v}_{N}^{t} \cdot N ( 1 ) )}^{2} & {( {v}_{N}^{t} \cdot N ( 2 ) )}^{2} & {( {v}_{N}^{t} \cdot N ( 3 ) )}^{2} & ⋯ & {( {v}_{N}^{t} \cdot N ( M ) )}^{2}\end{matrix} ] \times [ \begin{matrix}{w}_{1} \\ {w}_{2} \\ {w}_{3} \\ ⋯ \\ {w}_{M}\end{matrix} ] = [ \begin{matrix}1 \\ 1 \\ ⋯ \\ 1 \\ - 1 \\ - 1 \\ ⋯ \\ - 1\end{matrix} ] \qquad 12 )$$

A CBDS for recognizing a person similar to that described above in accordance with an embodiment of the invention may be used for many different applications. For example, the CBDS may be used in surveillance and alarm systems and in automotive collision warning and avoidance systems (CWAS). In a CWAS, performance of a CBDS may be augmented by other systems that process images acquired by a camera in the CWAS. Such other systems might operate to identify objects in the images that might confuse the CBDS and make it more difficult for it to properly identify a person. For example, the system may be augmented by a vehicle detection system or a crowd detection system, such as a crowd detection system described in PCT patent application entitled “Crowd Detection” filed on even date with the present application, the disclosure of which is incorporated herein by reference. As the density of people in the path of a vehicle increases and the people become a crowd, such as for example as often occurs at a zebra crossing of a busy street corner, cues useable to determine presence of a single individual often become masked and obscured by the commotion of the individuals in the crowd. Use of a crowd detection system in tandem with a pedestrian detection CBDS can therefore be advantageous.

Whereas in the above exemplary embodiment of a classifier in accordance with an embodiment of the invention, the classifier decides to which of two classes an instance belongs, a classifier in accordance with an embodiment of the invention may be used to classify instances into a class or classes of more than two classes. For example, each class may be represented by a different group of training vectors. To determine to which class a given instance belongs, the classifier determines a projection of the instance onto vectors of each group of training vectors and determines that the instance belongs to the class for which the projection is maximum. Optionally, the determination is performed by grouping all the classes into a first round of pairs and determining for which class of each pair a projection of the instance is largest. A second round of pairs is provided by grouping all the “winning” classes of the first round into second round pairs of classes and for each second round pair, a class for which the projection is maximum. The winning classes from the second round are again paired for a third round and so on. The process is repeated until optionally a last winning class remains.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A classifier for determining whether an instance belongs to a particular class of instances of a plurality of classes, the classifier comprising:
a plurality of first classifiers that operate on an instance to provide an indication as to which class the instance belongs, each of which classifiers is trained on a different subset of training instances from a same set of training instances wherein each training subset comprises a group of training instances that share at least one characteristic trait and different subsets have a different at least one characteristic trait; and
a second classifier that operates on the indications provided by the first classifiers to provide an indication as to which class the instance belongs.

2. A classifier according to claim 1 wherein each first classifier operates on a portion of an instance and a plurality of first classifiers operates on at least one portion of the instance.

3. A classifier according to claim 1 or claim 2 wherein a training subset of instances comprises a relatively small number of the total number of instances comprised in the set of training instances.

4. A classifier according to claim 3 wherein the number of instances is less than or equal to 10% of the total number of instances.

5. A classifier according to claim 3 wherein the number of instances is less than or equal to 5% of the total number of instances.

6. A classifier according to claim 3 wherein the number of instances is less than or equal to 3% of the total number of instances.

7. A classifier according to any of the preceding claims wherein the instances are images and the classifier determines whether an image comprises an image of a particular feature to determine to which class the image belongs.

8. A classifier according to claim 7 wherein the feature is a person.

9. An automotive collision warning and avoidance system comprising a classifier in accordance with any of the preceding claims.

10. A method of using a set of training instances to train a classifier comprising a plurality of first classifiers that operate on an instance to indicate a class of instances to which the instance belongs and a second classifier that uses indications provided by the first classifiers to determine a class to which the instance belongs, the method comprising:
grouping training instances from the set of training instances into a plurality of subsets of training instances wherein each training subset comprises a group of training instances that share at least one characteristic trait and different subsets have a different same at least one characteristic trait;
training each of the first classifiers on a different one of the training subsets; and
training the second classifier on substantially all the training instances.

11. A method according to claim 10 and comprising partitioning each instance into a plurality of portions and training a first classifier for each portion and a plurality of first classifiers for at least one portion.

12. A method according to claim 10 or claim 11 wherein a training subset of instances comprises a relatively small number of the total number of instances comprised in the set of training instances.

13. A method according to claim 12 wherein the number of instances is less than or equal to 10% of the total number of instances.

14. A method according to claim 12 wherein the number of instances is less than or equal to 5% of the total number of instances.

15. A method according to claim 12 wherein the number of instances is less than or equal to 3% of the total number of instances.

16. A method according to any of claims 10-15 wherein the instances are images and the classifier is trained to determine whether an image comprises an image of a particular feature to determine to which class the image belongs.

17. A method according to claim 16 wherein the feature is a person.

18. A classifier for determining a class to which an instance is represented by a descriptor vector in a space of vectors belongs comprising:
a plurality of sets of training vectors wherein vectors that belong to a same set represent training instances in a same class of instances and training vectors belonging to different sets represent training instances belonging to different classes of instances; and
an operator that determines for each set of vectors projections of the descriptor vector on all the training vectors in the set and determines to which class the instance belongs responsive to the projections on the sets.

19. A classifier according to claim 18 wherein the operator determines for each set of vectors a sum of the squares of the projections and that the instance belongs to the class of instances corresponding to the set of vectors for which the sum is largest.

20. A method of classifying an instance represented by a descriptor vector comprising:
providing a plurality of sets of training descriptor vectors wherein vectors that belong to a same set represent training instances in a same class of instances and training vectors belonging to different sets represent training instances belonging to different classes of instances;
determining for each set of training vectors projections of the descriptor vector on all the training vectors in the set; and
determining to which class the instance belongs responsive to the projections.

21. A method according to claim 20 and comprising determining a sum of the squares of the projections for each set and that the instance belong to the class of instances corresponding to the set of training vectors for which the sum is largest.
